(19) United States
(12) Patent Application Publication
(10) Pub. No.: US 2016/0161916 A1
(43) Pub. Date: Jun. 9, 2016

(54) DISPLAY DEVICE FOR A PORTABLE OBJECT SUCH AS A TIMEPIECE

(71) Applicant: The Swatch Group Research and Development Ltd, Marin (CH)

(72) Inventor: Nicolas FRANCOIS, Neuchatel (CH)

(73) Assignee: The Swatch Group Research and Development Ltd, Marin (CH)

(21) Appl. No.: 14/955,353

(22) Filed: Dec. 1, 2015

(30) Foreign Application Priority Data
Dec. 9, 2014 (EP) 14196933.7

(51) Int. Cl. G04B 19/243; G04C 17/00; G04G 9/12

(52) U.S. Cl. CPC G04B 19/243; G04G 9/12; G04C 17/00

(57) ABSTRACT

The display device comprises a dial including an opening, a rotating indicator member arranged to rotate behind the dial, and at least a first and a second group of motifs, wherein each of the groups of motifs is borne by a plane surface integral with the rotating indicator member, wherein the groups of motifs is arranged to appear in sequence through the opening in the dial during rotation of the rotating indicator member. The groups of motifs are each covered by a lenticular array, and each group of motifs is formed of at least a first motif having a first size and of a second motif of identical meaning to that of the first motif and having a second size. The motifs are fragmented into rectilinear sections parallel to the orientation of the motifs, and interleaved such that there is always one section of the second motif between each section of the first motif.

This application claims priority from European patent application No. 14196933.7 filed Dec. 9, 2014, the entire disclosure of which is hereby incorporated herein by reference.

### FIELD OF THE INVENTION

The present invention concerns a display device intended to be incorporated in a portable object, this display device including a dial comprising an opening which defines a display area, an indicator member being disposed behind the dial, and at least a first group of motifs extending in a plane parallel to the indicator member and arranged to appear through the opening provided in the dial.

### BACKGROUND OF THE INVENTION

There are known alphanumeric display devices which meet the above definition. In these devices, a rotating indicator member usually takes the form of a disc or a ring which bears a series of regularly spaced alphanumeric indications affixed to a circular track. These alphanumeric indications appear through an opening arranged in the dial commonly called the aperture and whose dimensions correspond to those of the alphanumeric indications to be displayed. The circular track of the disc or ring passes underneath the aperture and the alphanumeric indications therefore pass into the aperture when the indicator member turns, so that the various indications are displayed in sequence. Such display systems are very commonly used, for example in calendar watches.

A shared flaw of most of the alphanumeric display devices which meet the above description is the small size of the displayed indications.

Indeed, to avoid overlap between adjacent indications, the various indications must each be inscribed in a distinct sector of the circular track of the indicator member. In these conditions, it will be understood that the opening of a sector is limited to the angle obtained by dividing 360° by the number of indications distributed over the periphery of the circular track. In the case, for example, where the indications are the series of dates from 1 to 31, it can be calculated that the opening of the sectors is slightly less than 12°.

In order to overcome the aforementioned flaw, EP Patent Application No 1310839A1 describes a calendar watch whose aperture is adapted to provide an enlarged image of the alphanumeric indication to be displayed. To this end, the opening that forms the aperture is adapted in size and shape to receive a lens. The lens thus mounted in the opening acts as a magnifying glass, transmitting an enlarged image of the date indication, in order, in principle, to improve reading of the indication.

One drawback of this known solution is that the dimension of the numerals forming the indication to be displayed is practically equal to the diameter of the lens. In these conditions, it will be understood that the thickness of the lens in the display area is not even approximately constant. It is known that, when sufficiently large to be perceptible, variations in the thickness of the lens cause a deformation of the transmitted image. This phenomenon is known by the name of spherical aberration.

### BRIEF SUMMARY OF THE INVENTION

It is an object of the present invention to overcome the drawbacks of the prior art that have just been described. The present invention achieves this object by providing an alphanumeric display device conforming to the annexed claim 1.

It should be noted that the term “cylindrical” is used in the broad sense, the expression “cylindrical lens” designating here any lens including an optical axis and having, in cross-section, a constant profile over its entire length.

It should be noted that the “orientation” of a cylindrical lens corresponds to the orientation of the optical axis of the lens. Further, the orientation of a character corresponds to the conventional writing direction of this character in sequence with others in a text. It is known that the preferred writing direction of characters in most languages is the “horizontal” direction (the characters are written, depending on the case, from left to right or from right to left). It will be understood, however, that in the present context, the direction which will be called “horizontal” more accurately corresponds to the direction of a straight line passing through both eyes of a reader whose head is oriented in a conventional manner with respect to the characters.

### BRIEF DESCRIPTION OF THE DRAWINGS

Other features and advantages of the invention will appear upon reading the following description, given solely by way of non-limiting example, with reference to the annexed drawings, in which:

FIG. 1 is a top plan view of a timepiece movement associated with a prior art alphanumeric display device, the alphanumeric display device being formed by a date display for a calendar watch.

FIG. 2 is a schematic top plan view of a date disc forming the rotating indicator member of an alphanumeric display device according to a particular embodiment of the invention.

FIG. 3A is a schematic diagram illustrating a top view of one of the groups of characters of the display device of FIG. 2, this group of characters being borne by a plane surface and being formed of a first “3” and of a first “0” having a first size and of a second “3” and of a second “0” having a second size.

FIG. 3B is a cross-section of a lenticular array disposed above the group of characters of FIG. 3A.

FIG. 4 is a perspective view of a lenticular array disposed above a group of characters.

FIGS. 5A and 5B are a schematic views illustrating which character of the group of characters is visible to the observer depending on whether the observer's eyes are on one side or the other of the plane passing through the optical axis of the cylindrical lens and through the observer's eyes.

FIG. 6 is a schematic view of a first variant embodiment of the invention wherein a single lenticular lens array is arranged in the opening provided in the dial which covers the rotating indicator member on which at least one identical motif is printed in two different sizes.

FIGS. 7A and 7B are schematic views of a second variant embodiment of the invention wherein a liquid crystal display cell disposed underneath the opening provided in the dial displays at least one identical motif in two different sizes.

### DETAILED DESCRIPTION OF ONE EMBODIMENT OF THE INVENTION

The present invention proceeds from the general inventive idea which consists in arranging underneath a lenticular lens array two representations of the same motif in two different sizes. Depending on the angle at which the observer looks at the motifs, he will first of all see one of the motifs of a given size and then the other motif of a different size from that of the first motif seen, which causes a zoom effect making it possible to create a dynamic display.

The present invention will be described with reference to a rotating indicator member of the date ring type bearing thirty-one date indications enabling it to indicate the date on every day of a given month. It will be understood, however, that the present invention is not limited to such an embodiment and that the motifs visible underneath the lenticular lens array may be either numbers, letters, a logo, a decorative pattern or other design. Likewise, it is also possible to display a motif by means of a fixed or dynamic display, for example of the LCD type or similar.

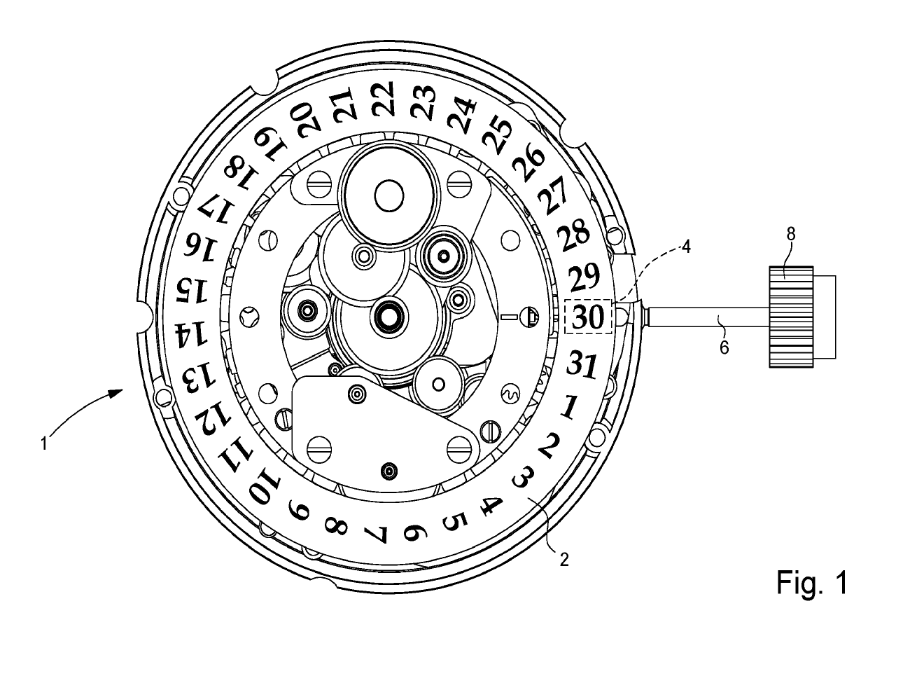

FIG. 1 is a top plan view of a timepiece movement for a calendar watch of the prior art. The timepiece movement 1 shown is arranged to drive various analogue display devices (not shown), notably hour and minute hands, in a conventional manner. It is also arranged to drive an alphanumeric display device which, in the illustrated example, is formed by a date display device. As can be seen in FIG. 1, the date display device includes a disc 2 which bears the series of numbers from 1 to 31 for displaying the various dates. In the usual manner, the numbers are arranged on disc 2 to appear in sequence through an open aperture in the watch dial (the location of the aperture is represented in FIG. 1 by a rectangle referenced 4).

Timepiece movement 1 may be either a mechanical movement, or an electromechanical movement, for example a quartz movement. It can be seen that the timepiece movement 1 shown in FIG. 1 is associated with a control stem 6 provided with a crown 8, arranged in the conventional manner to set the time and the date of the calendar watch.

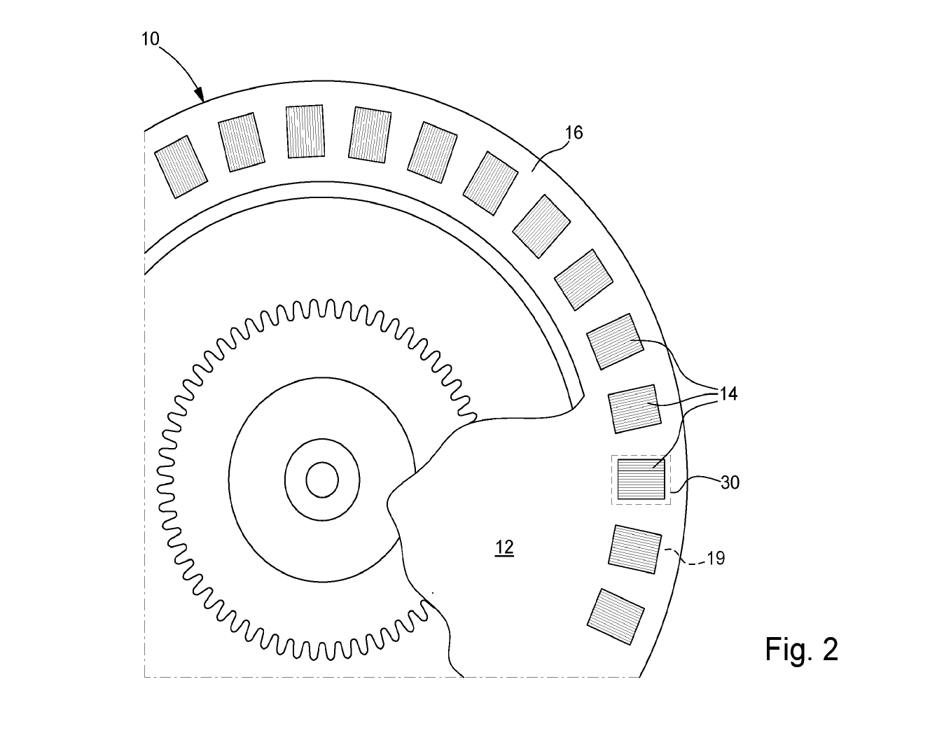

FIG. 2 is a partial schematic top plan view of a date ring 10 forming the rotating indicator member of an alphanumeric display device which conforms to a particular embodiment of the invention. In the illustrated example, date ring 10 forms part of a calendar mechanism for a timepiece (not shown), and it is arranged to be driven step-by-step by the timepiece movement, in order to rotate behind a dial 12. It should be noted that, apart from the alphanumeric display device, the timepiece movement of this example could, for example, be identical to the timepiece movement 1 of FIG. 1.

It was seen in the embodiment of FIG. 2 that the rotating indicator member is, for example, a date ring 10. Consequently, it bears thirty-one groups of characters, in order to display the dates of all the months of the year. According to the invention, each group of characters is covered by a lenticular array 14. In the illustrated example, the thirty-one lenticular arrays 14 are formed by as many strips affixed to a circular track 16 located at the periphery of date ring 10. It will be noted that not all the groups of characters that are visible through the various lenticular arrays 14 underneath which the groups of characters are arranged are shown in FIG. 2, to avoid overloading the diagram.

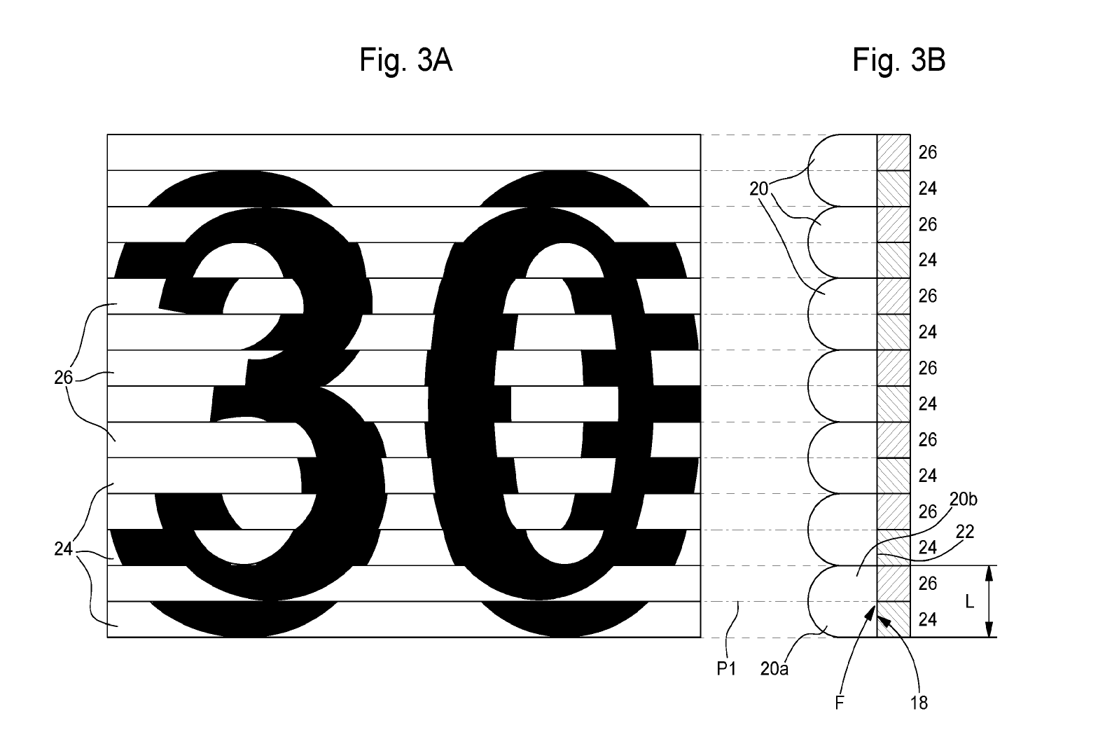

FIG. 3A is an enlarged schematic top plan view of one of the groups of characters of the display device of FIG. 2, and FIG. 3B is a cross-section of a lenticular array disposed above the group of characters of FIG. 3A. It is clear from FIG. 3A that the illustrated group of characters is formed of a first “3” and of a first “0” having a first size, and of a second “3” and of a second “0” having a second size that is different from the first size. According to the invention, the group of characters extends in a plane 18 located between lenticular array 14 and rotating indicator member 10. Further, the group of characters is covered by one of the lenticular arrays 14.

According to the invention, each lenticular array 14 is formed of a layer of juxtaposed cylindrical lenses 20 which extend parallel to each other. As can be seen in the cross-section of FIG. 3B, the “cylindrical” lenses 20 are not actually cylindrical. Indeed, it will be understood that the term “cylindrical” is used here in the broad sense, whereby the expression “cylindrical lens” designates any lens including an optical axis O-O, and having, in cross-section, an invariant profile over its entire length. It should be noted that lenticular arrays as such are already known. Lenticular arrays suitable for the embodiment of the invention are even commercially available from several companies. These arrays generally take the form of sheets of relatively large dimensions that can be cut to the desired size. These lenticular sheets are made of a stable, transparent material. They normally have a smooth back surface 22 which makes it possible to fix the sheet to a substrate. Further, according to an advantageous variant, lenticular array 14 may itself form plane 18 which bears the characters to be displayed. According to this latter variant, the characters are directly applied to the smooth back surface 22 of the lenticular sheet, for example by printing. To illustrate this variant, FIG. 3B shows dark areas at the base of lenticular array 14 which represent the ink used to print the characters.

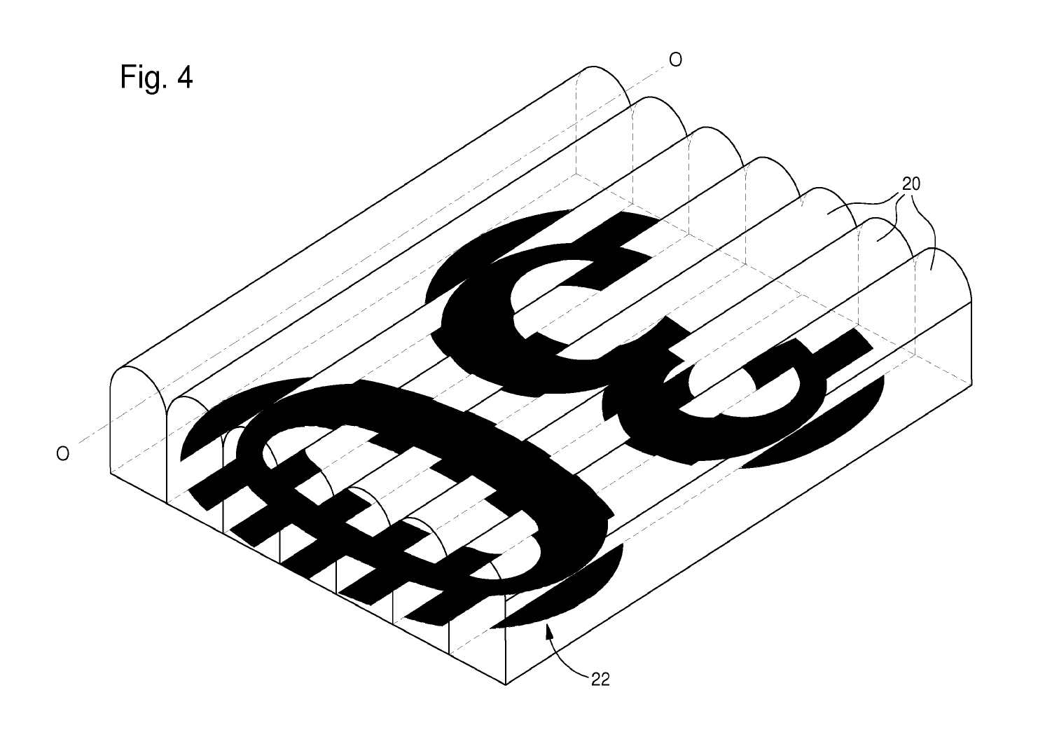

According to the invention, the cylindrical lenses 20 of lenticular arrays 14 have a focal length such that the focal plane F of the lenses coincides with the plane 18 in which the group of characters extends. As clearly shown in FIG. 4, the optical axes O-O of cylindrical lenses 20 are also oriented in the same direction as the characters of the group of characters (it will be clear in this regard that the orientation of a character such as a number is to be understood as the normal direction in which the number is written and read with the other number of the same size).

It can be seen that, in the group of characters shown in FIG. 3A, the first “3” and the first “0”, which have the same first size, are fragmented into rectilinear sections referenced 24. It can also be seen that the second “3” and the second “0”, which have a second size, are also fragmented into rectilinear sections referenced 26. Rectilinear sections 24 and 26 extend parallel to the normal writing direction of the characters, and they are interleaved so that there is always a rectilinear section 26, formed by a fragment of the numbers of the second size, between two rectilinear sections 24 formed by a fragment of the numbers of the first size. Finally, referring again to FIGS. 3A and 3B, it can be observed that the rectilinear sections 24 of the first character, like the rectilinear segments 26 of the second character, are arranged with the same pitch between them as that between cylindrical lenses 20 of lenticular array 14 which covers the group of characters.

According to the invention, each group of characters is formed of at least a first character having a first size and of a second character of identical meaning to that of the first character and having a second size that is different from the first size. It is important to note that, according to a variant of the invention (not shown), each group of characters could also include at least a third character of identical meaning to that of the first and second character and which has a third size, different from the first and second size. However, according to the particular embodiment forming the subject of the present invention, each of the numbers “3” and “0” is shown in only two different sizes. Therefore, assuming that each of cylindrical lenses 20 is divided by a vertical plane P1 into first and second halves 20a and 20b of the same width L, the first half 20a of cylindrical lens 20 covers at least one rectilinear section 24 of the first character, and the second half 20b of cylindrical lens 20 covers at least one rectilinear section 26 of the second character. It is important to note that this is a simplified variant embodiment of the invention. Indeed, progress made over the last few years in the field of printing resolution is such that it is entirely possible today to envisage having several rectilinear sections of the first character interleaved between rectilinear sections of the second character underneath the same cylindrical lens.

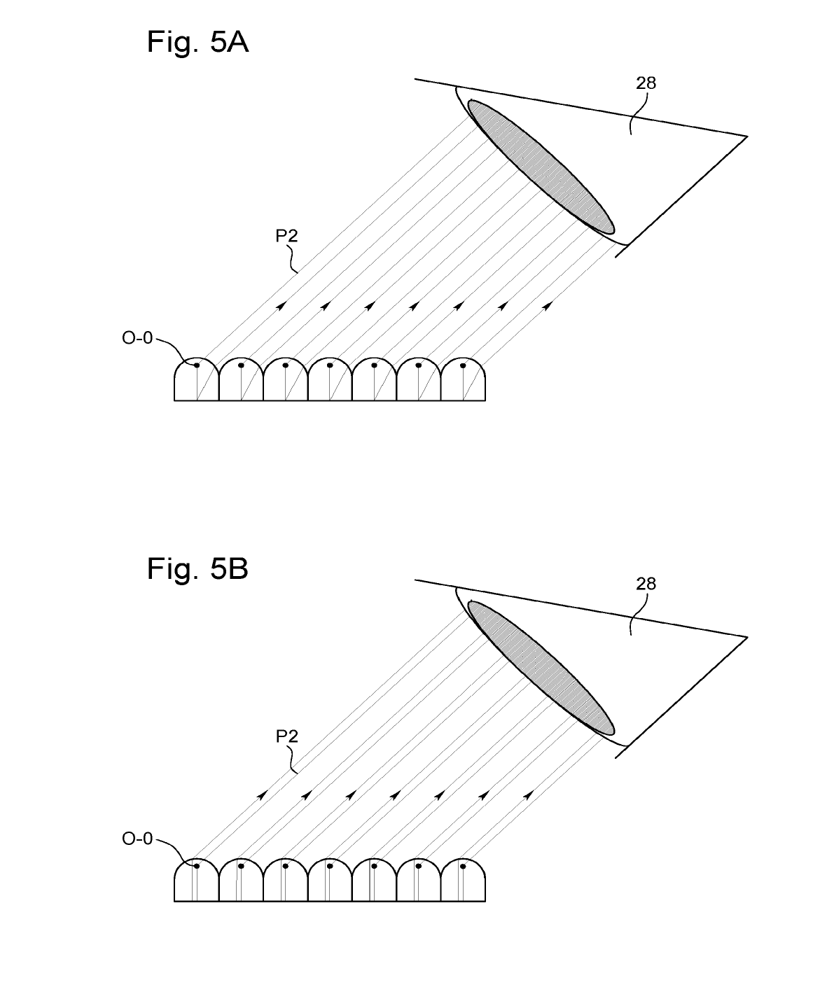

The operation of the invention will now be explained with reference to FIGS. 4 and 5A, 5B. As seen above, the cylindrical lenses 20 of lenticular arrays 14 have a focal length such that the focal plane F of the lenses coincides with the plane 18 in which the group of characters extends. In these conditions, each cylindrical lens 20 reflects towards the eyes of an observer 28 the enlarged image of only one of the rectilinear sections 24 or 26. This rectilinear section is that found on one side or the other of a plane P passing through the optical axis O-O of cylindrical lens 20 and through the eyes of observer 28. It will therefore be understood that, given that cylindrical lenses 20 of a lenticular array 14 are oriented in the same direction as the characters covered by said cylindrical lenses, this prevents the observer 28 seeing different images in each eye.

It was seen that, in the illustrated example, the first half 20a of cylindrical lens 20 covers a rectilinear section 24 of the first character, and the second half 20b of cylindrical lens 20 covers a rectilinear section 26 of the second character. Thus, when a group of characters is visible through an opening 30 arranged in dial 12, and an observer looks at opening 30 with his eyes on one side of plane P2, the observer sees the image formed by rectilinear sections 24 (image of the number “30” with figures of a first size). When, conversely, the observer's eyes are positioned on the other side of plane P2, he sees the image formed by rectilinear sections 26 (image of the number “30” with figures of a second size). In other words, the two images are switched depending on the viewing angle. Since the two images that are switched are two images of the same number, which are written in different sized figures, this is termed a “zoom” effect. The zoom effect draws attention to the group of characters visible through opening 30 by creating an animated image. In order to obtain a clear image of a group of characters, it is advantageous for rectilinear sections 24 and 26 to be very thin. To this end, it is possible to use, for example, a lenticular array with 40 LPI (40 cylindrical lenses per inch). It can be calculated that the width of the cylindrical lenses of such an array is approximately ⅔rd of a millimetre. In these conditions, the width of the rectilinear sections may be around ⅓rd of a millimetre.

It will also be clear that various alterations and/or improvements evident to those skilled in the art may be made to the embodiment described herein without departing from the scope of the present invention defined by the annexed claims. In particular, each group of characters may include a third character of identical meaning to that of the first and second character and having a third size that is different from the first and the second size, the third character being fragmented into rectilinear sections parallel to the orientation of the characters and interleaved with the first and second characters so that there is always one section of the first character and one section of the second character between two sections of the third character. It will be understood that, provided that the three types of sections always follow each other in the same order, the “zoom” effect can be made even more spectacular by using a number of sizes greater than two.

In the embodiment described in the preceding pages, the rotating indicator member is a date ring which bears thirty-one groups of characters, in order to display the dates of all the months of the year. According to the invention, each group of characters is covered by a lenticular array.

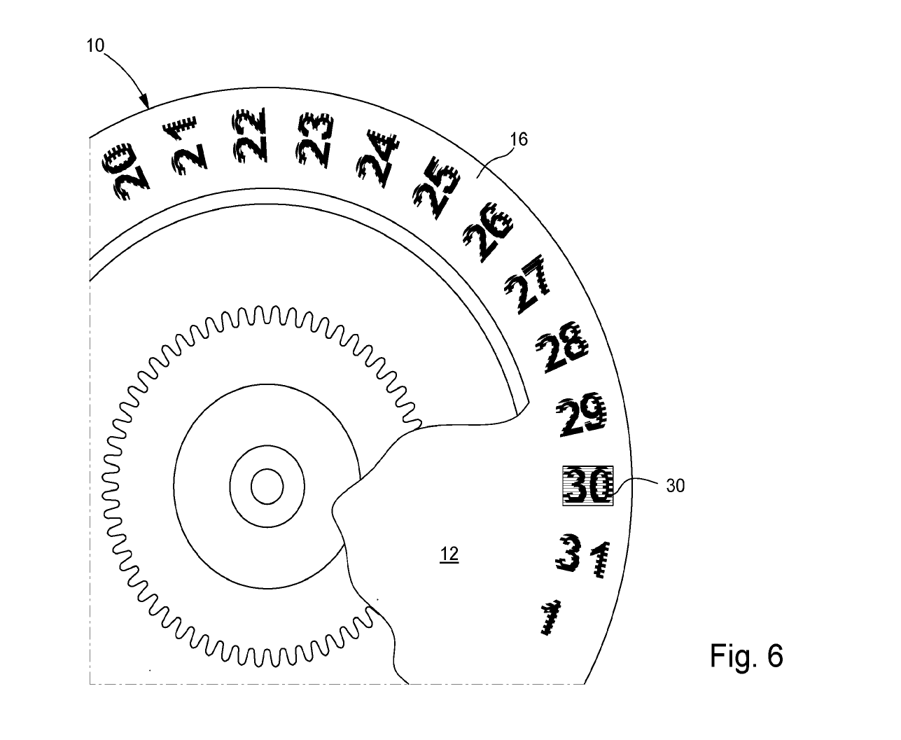

According to an advantageous variant of the invention illustrated in FIG. 6, instead of covering each group of characters with a lenticular lens array, a single lenticular lens array 14 is arranged in opening 30 provided in dial 12 which covers rotating indicator member 10. Consequently, all the groups of characters borne by the rotating indicator member will gradually pass under the lenticular lens array as the rotating indicator member rotates. Such a solution requires fewer components and less manufacturing time and is therefore more economical. Of course, the groups of characters borne by the rotating indicator member conform to the invention, i.e. each group of characters is formed of at least twice the same motif, in two different sizes, these motifs being cut into rectilinear sections interleaved with each other. In the particular example shown in FIG. 6, it can be seen that each group of characters is formed of twice the same date indication in two different sizes. It will also be noted that the optical properties described above with reference to the embodiment of the invention wherein each group of characters is covered by a lenticular lens array are also valid in the case of FIG. 6, where a single lenticular lens array is fixed in the opening provided in the dial and wherein the groups of characters are borne by the rotating indicator member.

Finally, it will be noted that the example described above concerns a rotating indicator member that bears numerical indications. It will be understood, however, that the invention is not limited to such an embodiment and that the rotating indicator member may bear any type of motif such as, in a non-limiting manner, letters or even a logo.

In the particular case of a logo, the group of motifs according to the invention will be formed of two identical logos in two different sizes cut into rectilinear sections of the same thickness, which will be interleaved with each other in an identical direction to the direction in which the cylindrical lenses extend.

According to a simplified variant embodiment of the invention, it is even possible to envisage that the display device of the invention can only display one motif in two different sizes. Such a display device may be advantageous in the case where it is desired to display only, for example, a brand logo in two different sizes.

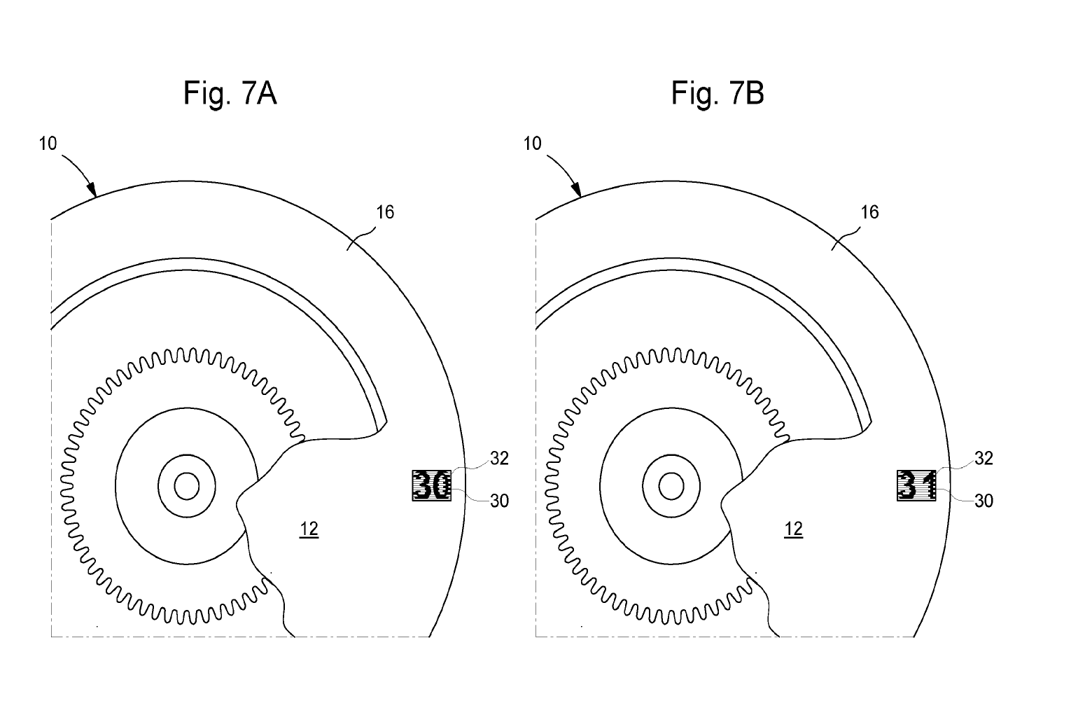

According to another advantageous variant, it is possible to envisage using as the indicator member a digital display device, such as a liquid crystal display cell 32 disposed plumb with opening 30 provided in dial 12 and in which is arranged a single lenticular lens array 14. This liquid crystal display cell 32 may provide a steady or unchanging display, for example of a logo in two different sizes. As illustrated in FIGS. 7A and 7B, this display cell 32 can also provide a dynamic display of at least a first (FIG. 7A) and a second (FIG. 7B) group of characters, each of the first and second groups of characters being formed of at least a first character having a first size and of a second character of identical meaning to that of the first character and having a second size that is different from the first. In both cases, the characters will be cut into rectilinear sections of the same thickness which will be formed by the display electrodes of liquid crystal display cell 32.

### LIST OF PARTS

Timepiece movement 1
Disc 2
Aperture 4
Control stem 6
Crown 8
Date ring 10
Dial 12
Lenticular array 14
Circular track 16
Plane 18
Cylindrical lens 20
Smooth back surface 22
Rectilinear sections 24 of the first character
Rectilinear sections 26 of the second character
Observer 28
Opening 30
Liquid crystal display cell 32
Optical axis O-O
Focal plane F
Plane P1
Width L
Plane P2

What is claimed is:

1. Display device intended to be incorporated into a portable object, wherein the display device includes a dial in which is provided an opening, which defines a display area, wherein an indicator member is arranged behind the dial, and wherein at least a first group of motifs extends in a plane parallel to the indicator member and are arranged to appear through the opening provided in the dial, wherein the motifs of the first group of motifs always are oriented in the same direction when said motifs appear through the opening, wherein:
the group of motifs is formed of at least a first motif having a first size and of a second motif of identical meaning to that of the first motif and having a second size that is different from the first size;
the group of motifs is seen through a lenticular array formed of a plurality of juxtaposed cylindrical lenses extending parallel to each other, wherein the cylindrical lenses of the lenticular array have a focal length such that the focal plane of the cylindrical lenses coincides with the plane in which the group of motifs extends;
the first motif of the group of motifs and the second motif of the same group of motifs as the first motif are fragmented into rectilinear sections which extend parallel to each other, wherein the rectilinear sections are interleaved with each other so that there is always one section of the second motif located between two sections of the first motif.

2. Display device according to claim 1, wherein the indicator member rotates and wherein at least one second group of motifs is arranged in the plane parallel to the rotating indicator member, wherein the groups of motifs are arranged to appear one after the other through the opening provided in the dial during rotation of the rotating indicator member.

3. Display device according to claim 2, wherein a single lenticular lens array is arranged in the opening provided in the dial which covers the rotating indicator member.

4. Display device according to claim 2, wherein the rotating indicator member includes a plurality of lenticular arrays, wherein the groups of motifs each being covered by one of the lenticular arrays.

5. Display device according to claim 4, wherein each of the lenticular arrays that covers a group of motifs has a smooth back surface that forms the plane in which the group of motifs is formed.

6. Display device according to claim 2, wherein the plane in which the group of motifs is formed consists of a portion of the surface of the rotating indicator member.

7. Display device according to claim 3, wherein the plane in which the group of motifs is formed consists of a portion of the surface of the rotating indicator member.

8. Display device according to claim 1, wherein each group of motifs includes a third motif of identical meaning to that of the first and second motif and having a third size that is different from the first and second size, wherein the third motif is fragmented into rectilinear sections which extend parallel to each other, wherein the rectilinear sections of the third motif is interleaved with the rectilinear sections of the first and second motif so that there is always one section of the first motif and one section of the second motif between two sections of the third motif.

9. Display device according to claim 1, wherein the motifs of the first and second groups of motifs are alphanumeric characters which are written in the same direction, wherein the cylindrical lenses are oriented in the same direction as the direction of writing of the alphanumeric characters of the group of alphanumeric characters covered by the cylindrical lenses, wherein the alphanumeric characters are fragmented into rectilinear sections which extend parallel to each other in the direction of writing of the alphanumeric characters.

10. Display device according to claim 1, wherein the indicator member is a liquid crystal display cell which provides either an unchanging display of a motif in two different sizes, or a dynamic display of at least a first and a second group of motifs, wherein each of the first and second groups of motifs are formed of at least a first motif having a first size and of a second motif of identical meaning to that of the first motif and having a second size that is different from the first size, the motifs being cut into rectilinear sections of the same thickness which are formed by the display electrodes of the liquid crystal display cell.
